(19) United States
(12) Patent Application Publication
(10) Pub. No.: US 2010/0132865 A1
(43) Pub. Date: Jun. 3, 2010

(54) Non-Pneumatic Tire

(75) Inventors: Masanori Iwase, Osaka (JP); Masahiro Segawa, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/624,528

(22) Filed: Nov. 24, 2009

(30) Foreign Application Priority Data
Nov. 28, 2008 (JP) 2008-304717

(51) Int. Cl. B60C 7/00

(52) U.S. Cl. 152/301

(57) ABSTRACT

The invention provides a non-pneumatic tire in which a fluctuation in a circumferential direction of tire rigidity is hard to be generated by a positional relationship between a spoke position and a center position of a ground surface, and a buckling of a ground portion between the spokes can be sufficiently suppressed. In a non-pneumatic tire T comprising a support structure body SS supporting a load from a vehicle, the support structure body SS includes an inner annular portion 1, an intermediate annular portion 2 concentrically provided in an outer side of the inner annular portion 1, an outer annular portion 3 concentrically provided in an outer side of the intermediate annular portion 2, a plurality of inner coupling portions 4 coupling the inner annular portion 1 and the intermediate annular portion 2, and a plurality of outer coupling portions 5 coupling the outer annular portion 3 and the intermediate annular portion 2, wherein the inner coupling portions 4 and the outer coupling portions 5 are divided in a tire width direction, are independent in a tire circumferential direction, and are provided so as to be shifted from each other in the tire circumferential direction per zones which are divided in the tire width direction.

### BACKGROUND OF THE INVENTION

1. Field of the Invention

The present invention relates to a non-pneumatic tire provided with a support structure body supporting a load from a vehicle, serving as a tire structure member, and preferably relates to a non-pneumatic tire which can be used in place of a pneumatic tire.

2. Description of the Related Art

A pneumatic tire has a function of supporting a load, a performance of absorbing a shock from a ground surface, and a performance of transmitting a power (accelerating, stopping and direction changing performance), and is accordingly employed in various vehicles, particularly a bicycle, a motor cycle, an automobile and a truck.

Particularly, these capabilities greatly have contributed to a development of the automobile and other motor vehicles. Further, the shock absorbing performance of the pneumatic tire is useful in a transportation cart for medical equipment and an electronic device, and for other intended uses.

As a conventional non-pneumatic tire, for example, a solid tire, a spring tire, a cushion tire and the like exist, however, they do not have an excellent performance of the pneumatic tire. For example, the solid tire and the cushion tire support the load based on a compression of a ground portion, however, this kind of tire is heavy and rigid, and does not have a shock absorbing performance like the pneumatic tire. Further, in the non-pneumatic tire, it is possible to improve the cushion performance by enhancing elasticity, however, there is a problem that such a load support performance or durability of the pneumatic tire is deteriorated.

Accordingly, in Japanese Unexamined Patent Publication No. 2005-500932, there is proposed a non-pneumatic tire having a reinforced annular band supporting a load applied to a tire, and a plurality of web spokes transmitting a load force by a tensile force between the reinforced annular band and a wheel or a hub, for the purpose of developing a non-pneumatic tire having a similar operating characteristic to the pneumatic tire.

However, in the non-pneumatic tire described in Japanese Unexamined Patent Publication No. 2005-500932, it has been known that a fluctuation of a vertical load tends to be generated due to a positional relationship between a position of the web spoke and a center position of the ground surface, in the case where the vertical load is applied so as to have an identical deflection amount. In other words, in the case where the center position between the web spokes S is positioned at the center TC of the ground surface as shown in FIG. 8A, a reaction force from the tire becomes small (soft), and in the case where a position of a lower end of the web spoke S is positioned at the center TC of the ground surface as shown in FIG. 8B, the reaction force from the tire becomes large (rigid), a circumferential fluctuation of the tire rigidity (which may be, hereinafter, simply referred to as rigidity fluctuation) is seen in a ground state between the both. As a result, there is a risk that uniformity is deteriorated, and various performances are deteriorated due to an uneven grounding.

Further, since the non-pneumatic tire described in Japanese Unexamined Patent Publication No. 2005-500932 has a space between the web spokes which are adjacent in the circumferential direction, the rigidity of the annular band becomes low in a region between the web spokes. Accordingly, the annular band generates a buckling between the web spokes at the time of grounding, and there is a problem that the annular band runs into destruction in addition to a vibration and noise, and an abnormal abrasion of a tread.

In order to suppress such a circumferential fluctuation of the tire rigidity, and in order to prevent the buckling of the ground portion between the web spokes, Japanese Patent No. 3966895 describes a non-pneumatic tire configured by forming a spoke structure body in which fins coupling between an annular outer peripheral member and an inner peripheral member in a diametrical direction are intermittently arranged so as to be spaced in a circumferential direction as a unit structure body which is divided into a plurality of zones in a tire width direction, shifting the positions of the fins in the circumferential direction between the unit structure bodies, forming the unit structure body as a unit structure body which is divided in a plurality of sections in the circumferential direction, and integrating and bonding all the unit structure bodies. The non-pneumatic tire is structured such that the fins which are shifted from each other in the circumferential direction act on an improvement of a rigidity of the outer peripheral member between the fins in the adjacent zones, thereby making the circumferential fluctuation of the tire rigidity small, and suppressing the buckling of the outer peripheral member.

### SUMMARY OF THE INVENTION

However, it has been known that the non-pneumatic tire described in Japanese Patent No. 3966895 has a similar structure to the non-pneumatic tire described in Japanese Unexamined Patent Publication No. 2005-500932, in the individual zone, and is not sufficient in an effect of suppressing the buckling of the ground portion between the web spokes.

Accordingly, an object of the present invention is to provide a non-pneumatic tire in which a fluctuation in a circumferential direction of tire rigidity is hard to be generated by a positional relationship between a spoke position and a center position of a ground surface, and a buckling of a ground portion between the spokes can be sufficiently suppressed.

The object mentioned above can be achieved by the present invention described as follows.

In other words, in accordance with the present invention, there is provided a non-pneumatic tire comprising:

a support structure body supporting a load from a vehicle,

the support structure body including:

an inner annular portion,

an intermediate annular portion concentrically provided in an outer side of the inner annular portion,

an outer annular portion concentrically provided in an outer side of the intermediate annular portion,

a plurality of inner coupling portions coupling the inner annular portion and the intermediate annular portion; and

a plurality of outer coupling portions coupling the outer annular portion and the intermediate annular portion, wherein

the inner coupling portions and the outer coupling portions are divided in a tire width direction, are independent in a tire circumferential direction, and are provided so as to be shifted from each other in the tire circumferential direction per zones which are divided in the tire width direction.

In accordance with the non-pneumatic tire of the present invention, the fluctuation in the circumferential direction of the tire rigidity is hard to be generated by the positional relationship between the spoke position and the center position of the ground surface, and it is possible to sufficiently suppress the buckling of the ground portion between the spokes. A description will be given below of operations and effects of the non-pneumatic tire in accordance with the structure mentioned above.

In the conventional non-pneumatic tire in which the intermediate annular portion is not interposed, in a case where a position of a lower end of a web spoke S1 is set in a ground surface center TC as shown in FIG. 1A upon application of the a vertical load, a bending force is hard to be generated in the web spoke S1, and a buckling of the web spoke S1 is hard to be generated, however, in a case where a center position of a web spoke S3 is set in the ground surface center TC as shown in FIG. 1B, a bending force is generated in the web spoke S3 due to a deformation of a wheel tread, a displacement in a loading direction, or the like, so that a buckling (a bending deformation in a direction of an outside arrow) tends to be generated. As a result, upon the application of the vertical load in such a manner as to obtain the same deflection amount, a reaction force from the tire becomes larger (harder) in a positional relationship shown in FIG. 1A, in comparison with a positional relationship shown in FIG. 1B, so that a rigidity fluctuation is generated in a ground state of the both.

On the other hand, in a non-pneumatic tire in which an intermediate annular portion 2 is interposed, in a case where a position of a lower end of an outer coupling portion 5 is set in the ground surface center TC as shown in FIG. 1C upon application of the vertical load, the buckling of the outer coupling portion 5 and the inner coupling portion 4 is hard to be generated in the same manner as FIG. 1A, and in a case where a center position of the outer coupling portion 5 is set in the ground surface center TC as shown in FIG. 1D, the intermediate annular portion 2 applies a reinforcement caused by a tensile force (a tensile force in an inside inward arrow) and a reinforcement caused by a compression (a compressing force in an outside inward arrow) to a bending force generated in the outer coupling portion 5 and the inner coupling portion 4, whereby the buckling of the outer coupling portion 5 and the inner coupling portion 4 is hard to be generated. As a result, in the non-pneumatic tire in accordance with the present invention, the buckling is hard to be generated in a ground state of the both in comparison with the related art, a deflection amount and a vertical load until the buckling is generated become large (that is, a break point at which the buckling starts being generated becomes high), and it is possible to set a region wide in which a rigidity fluctuation is small between the positional relationship shown in FIG. 1C and the positional relationship shown in FIG. 1D. Accordingly, it is possible to provide a non-pneumatic tire in which the circumferential fluctuation of the tire rigidity is hard to be generated by the positional relationship between the spoke position and the ground surface center position.

Further, in accordance with the non-pneumatic tire of the present invention, since the outer coupling portions are divided in the tire width direction, are independent in the tire circumferential direction, and are provided so as to be shifted in the tire circumferential direction per zones divided in the tire width direction, the outer coupling portions which are shifted from each other in the tire circumferential direction can improve the rigidity of the outer annular portion between the outer coupling portions which are adjacent in the tire circumferential direction in the adjacent zone. Accordingly, it is possible to sufficiently suppress the buckling of the ground portion between the outer coupling portions (the spokes). Further, since the non-pneumatic tire in accordance with the present invention is provided with the intermediate annular portion mentioned above per zones which are divided in the tire width direction, the fluctuation in the circumferential direction of the tire rigidity becomes small in each of the zones.

Therefore, in accordance with the present invention, it is possible to provide the non-pneumatic tire in which the fluctuation in the circumferential direction of the tire rigidity is hard to be generated by the positional relationship between the spoke position and the ground surface center position, and it is possible to sufficiently suppress the buckling of the ground portion between the spokes.

In the non-pneumatic tire in accordance with the present invention, it is preferable that each of the inner coupling portion and the outer coupling portion is extended in a direction which is inclined from the tire diametrical direction. In accordance with this structure, either in a case where the position of the lower end of the outer coupling portion 5 is set in the ground surface center TC as shown in FIG. 2A, or in a case where the center position of the outer coupling portion 5 is set in the ground surface center TC as shown in FIGS. 2B and 2C, the intermediate annular portion 2 receives the compression force and the tensile force with respect to the bending force generated in the outer coupling portion 5 and the inner coupling portion 4, thereby burdening the intermediate annular portion 2 with the deformation of the inner coupling portion 4 and the outer coupling portion 5, so that the deformation of the support structure body can be uniformed while the buckling of the outer coupling portion 5 and the inner coupling portion 4 is hard to be generated.

In the non-pneumatic tire in accordance with the present invention, it is preferable that the outer annular portion is continuous in the tire circumferential direction and is reinforced by a reinforcing fiber. In a case where the outer annular portion is structured by bonding divided parts by an adhesion or the like without being continuous in the tire circumferential direction, an adhesion to a belt layer or the like provided in an outer side of the outer annular portion is insufficient, and the tensile force is not effectively applied to the coupling portion (the inner coupling portion and the outer coupling portion) at a time when the load is applied. On the other hand, in the non-pneumatic tire in accordance with the present invention, since the outer annular portion is continuous in the tire circumferential direction, and is reinforced by the reinforcing fiber, the adhesion between the outer annular portion and the belt layer or the like becomes sufficient.

### BRIEF DESCRIPTION OF THE DRAWINGS

FIGS. 1A to 1D are explanatory views for explaining operations and effects of a non-pneumatic tire in accordance with the present invention;

FIGS. 2A to 2C are explanatory views for explaining the operations and effects of the non-pneumatic tire in accordance with the present invention;

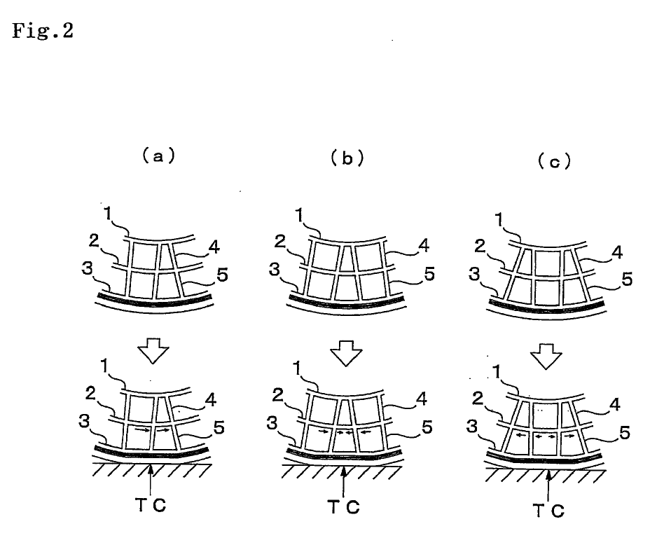

FIGS. 3A and 3B are a front elevational view and a side elevational view showing one example of the non-pneumatic tire in accordance with the present invention;

FIG. 4 is a perspective view enlarging a part of the non-pneumatic tire in accordance with the present invention;

FIG. 5 is a graph showing results of a rigidity fluctuation test in examples and comparative examples;

FIG. 6 is a graph showing results of the rigidity fluctuation test in the comparative examples;

FIG. 7 shows results of a bench tire single noise test; and

FIGS. 8A and 8B are explanatory views for explaining a problem of a conventional non-pneumatic tire.

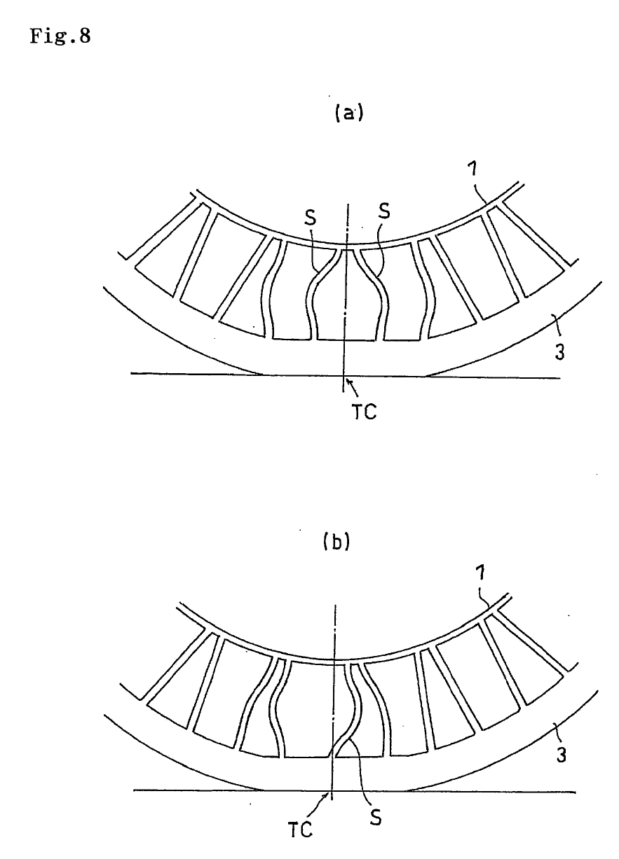

### DETAILED DESCRIPTION OF THE PREFERRED EMBODIMENTS

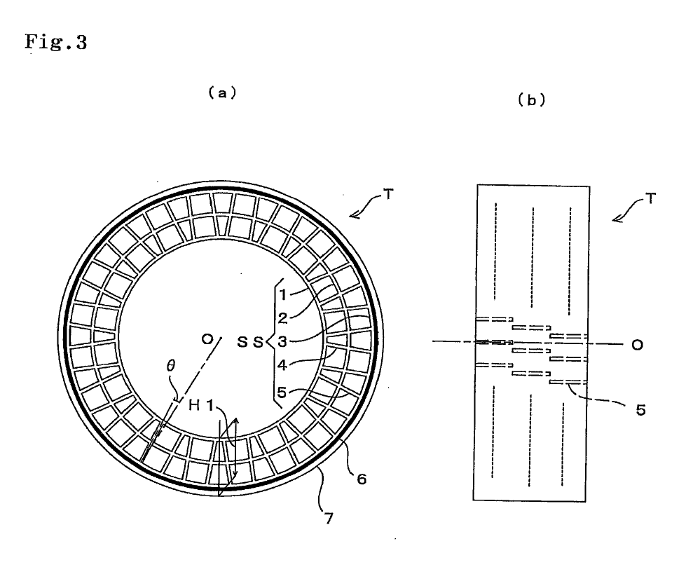

A description will be given below of an embodiment in accordance with the present invention with reference to the accompanying drawings. First of all, a description will be given of a structure of a non-pneumatic tire in accordance with the present invention. FIG. 3 shows an example of the non-pneumatic tire, in which FIG. 3A is a front elevational view and FIG. 3B is a side elevational view. In this case, reference symbol O denotes an axial core, and reference symbol H1 denotes a tire cross sectional height, respectively.

The non-pneumatic tire T is provided with a support structure body SS supporting a load from a vehicle. It is sufficient for the non-pneumatic tire T according to the present invention to include such an support structure body SS, and the non-pneumatic tire T may also include a member corresponding to a tread, a reinforcing layer, a member for adapting to an axle and a rim, and the like at an outer side (outer periphery side) or an inner side (inner periphery side) of the support structure body SS.

In the non-pneumatic tire T according to the present embodiment, as shown by the front elevational view in FIG. 3, the support structure body SS is provided with an inner annular portion 1, an intermediate annular portion 2 provided concentrically in an outer side thereof, an outer annular portion 3 provided concentrically in an outer side thereof, a plurality of inner coupling portions 4 coupling the inner annular portion 1 and the intermediate annular portion 2, and a plurality of outer coupling portions 5 coupling the outer annular portion 3 and the intermediate annular portion 2.

In view of improving uniformity, the inner annular portion 1 is preferably formed in a cylindrical shape having a fixed thickness. Further, projections and depressions or the like for maintaining a fitting performance is preferably provided in an inner peripheral surface of the inner annular portion 1, for installing to the axle or the rim.

A thickness of the inner annular portion 1 is preferably set between 2 and 7%, and more preferably set between 3 and 6%, in view of achieving weight saving and an improvement in durability while sufficiently transmitting a force to the inner coupling portion 4.

An inner diameter of the inner annular portion 1 is appropriately determined in correspondence to a dimension or the like of the rim or the axle to which the non-pneumatic tire T is installed, however in the present invention, the inner diameter of the inner annular portion 1 can be made substantially smaller than the conventional one, for including the intermediate annular portion 2. In the case of assuming a substitution of the general pneumatic tire, the inner diameter is preferably between 250 and 500 mm, and more preferably between 330 and 440 mm.

The width in the axial direction of the inner annular portion 1 is appropriately determined in correspondence to an intended use, a length of the axle or the like, however, in the case of assuming a substitution of the general pneumatic tire, the width is preferably between 100 and 300 mm, and more preferably between 130 and 250 mm.

A tensile modulus of the inner annular portion 1 is preferably set between 5 and 180000 MPa, and more preferably set between 7 and 50000 MPa, in view of achieving weight saving, an improvement in durability and an installing characteristic while sufficiently transmitting the force to the inner coupling portion 4. Note that the tensile modulus in the present invention is a value obtained by carrying out a tensile test according to JIS K7312 and calculating from a tensile stress at the time of elongating at 10%.

The support structure body SS in the present invention is formed by an elastic material, however, it is preferable in view of capability of integrally forming at the time of manufacturing the support structure body SS, that the inner annular portion 1, the intermediate annular portion 2, the outer annular portion 3, the inner coupling portion 4 and the outer coupling portion 5 are basically made of the same material except the reinforcing structure.

The elastic material in the present invention indicates a material in which a tensile test is carried out according to JIS K7312, and a tensile modulus calculated from the tensile stress at the time of 10% elongation is not more than 100 MPa. As the elastic material of the present invention, the tensile modulus is preferably between 5 and 100 MPa, and more preferably between 7 and 50 MPa, in view of applying a suitable rigidity while obtaining a sufficient durability. As the elastic material used as the base material, a thermoplastic elastomer, a cross linked rubber, and the other resins can be listed up.

As the thermoplastic elastomer, there can be listed up a polyester elastomer, a polyolefin elastomer, a polyamide elastomer, a polystyrene elastomer, a polyvinyl chloride elastomer, a polyurethane elastomer and the like. As a rubber material constructing the cross linked rubber material, there can be listed up synthetic rubbers such as a styrene butadiene rubber (SBR), a butadiene rubber (BR), an isoprene rubber (IIR), a nitrile rubber (NBR), a hydrogenation nitrile rubber (a hydrogenation NBR), a chloroprene rubber (CR), an ethylene propylene rubber (EPDM), a fluorine-contained rubber, a silicone rubber, an acrylic rubber, an urethane rubber and the like, in addition to a natural rubber. Two or more kinds of rubber materials may be used together as necessary.

As the other resins, a thermoplastic resin, or a thermosetting resin can be listed up. As the thermoplastic resin, there can be listed up a polyethylene resin, a polystyrene resin, a polyvinyl chloride resin and the like, and as the thermosetting resin, there can be listed up an epoxy resin, a phenol resin, a polyurethane resin, a silicone resin, a polyimide resin, a melamine resin and the like.

In the elastic material mentioned above, in view of a forming and working characteristic and a cost, the polyurethane resin is preferably used. Note that a foamed material may be used as the elastic material, and a material obtained by foaming the thermoplastic elastomer, the cross linked rubber, or the other resin described above can be used.

The support structure body SS integrally formed by the elastic material is preferably structured such that the inner annular portion 1, the intermediate annular portion 2, the outer annular portion 3, the inner coupling portion 4 and the outer coupling portion 5 are reinforced by a reinforcing fiber.

As the reinforcing fiber, there can be listed up a reinforcing fiber such as a long fiber, a short fiber, a woven fiber, an unwoven fiber or the like, however, it is preferable to use a net state fiber assembly constituted by fibers arranged in the tire axial direction and fibers arranged in the tire circumferential direction, as a form using the long fiber.

As the kind of the reinforcing fiber, for example, there can be listed up a polyimide cord such as a rayon cord, a nylon-6, 6 or the like, a polyester cord such as a polyethylene terephthalate or the like, an aramid cord, a glass fiber cord, a carbon fiber, a steel cord and the like.

In the present invention, it is possible to employ reinforcement by granular filler, and reinforcement by a metal ring or the like, in addition to the reinforcement using the reinforcing fiber. As the granular filler, there can be listed up ceramics such as a carbon black, silica, an alumina or the like, other inorganic filler, or the like.

The shape of the intermediate annular portion 2 is preferably formed in a cylindrical shape having a fixed thickness, in view of improving uniformity. In this case, the shape of the intermediate annular portion 2 is not limited to the cylindrical shape, but may be set to a polygonal tubular shape and the like.

The thickness of the intermediate annular portion 2 is preferably between 3 and 10% the tire cross sectional height H1, and more preferably between 4 and 9%, in view of realizing weight saving and improvement in durability while sufficiently reinforcing the inner coupling portion 4 and the outer coupling portion 5.

An inner diameter of the internal annular portion 2 goes beyond an inner diameter of the inner annular portion 1 and becomes less than an inner diameter of the outer annular portion 3. In this case, it is preferable to set the inner diameter of the internal annular portion 2 to an inner diameter obtained by adding 20 to 80% of a value obtained by subtracting the inner diameter of the inner annular portion 1 from the inner diameter of the outer annular portion 3, to the inner diameter of the inner annular portion 1, in view of improving the reinforcing effect of the inner coupling portion 4 and the outer coupling portion 5 as mentioned above, and it is more preferable to set to an inner diameter obtained by adding 30 to 60% of the value to the inner diameter of the inner annular portion 1.

The width in the axial direction of the intermediate annular portion 2 is appropriately determined in correspondence to an intended use or the like, however, in the case of assuming the substitution of the general pneumatic tire, the width is preferably between 100 and 300 mm, and more preferably between 130 and 250 mm.

The tensile modulus of the intermediate annular portion 2 is preferably between 8000 and 180000 MPa, and more preferably between 10000 and 50000 MPa, in view of achieving an improvement in durability and the improvement in load capacity by sufficiently reinforcing the inner coupling portion 4 and the outer coupling portion 5.

Since it is preferable that the tensile modulus of the intermediate annular portion 2 is higher than that of the inner annular portion 1, the fiber reinforcing material obtained by reinforcing the thermoplastic elastomer, the cross linked rubber, or the other resin by the fiber or the like is preferable.

The shape of the outer annular portion 3 is preferably set to a cylindrical shape having a fixed thickness, in view of improving the uniformity. The thickness of the outer annular portion 3 is preferably between 2 and 7% the tire cross sectional height H1, and more preferably between 2 and 5%, in view of achieving the weight saving and the improvement in durability while sufficiently transmitting the force from the outer coupling portion 5.

The inner diameter of the outer annular portion 3 is appropriately determined in correspondence to an intended use or the like thereof, however, in the present invention, since the intermediate annular portion 2 is provided, it is possible to make the inner diameter of the outer annular portion 3 larger than the conventional one. In this case, in the case of assuming the substitution of the general pneumatic tire, the inner diameter is preferably between 420 and 750 mm, and more preferably between 480 and 680 mm.

The width in the axial direction of the outer annular portion 3 is appropriately determined in correspondence to an intended use or the like, however, in the case of assuming the substitution of the general pneumatic tire, the width is preferably between 100 and 300 mm, and more preferably between 130 and 250 mm.

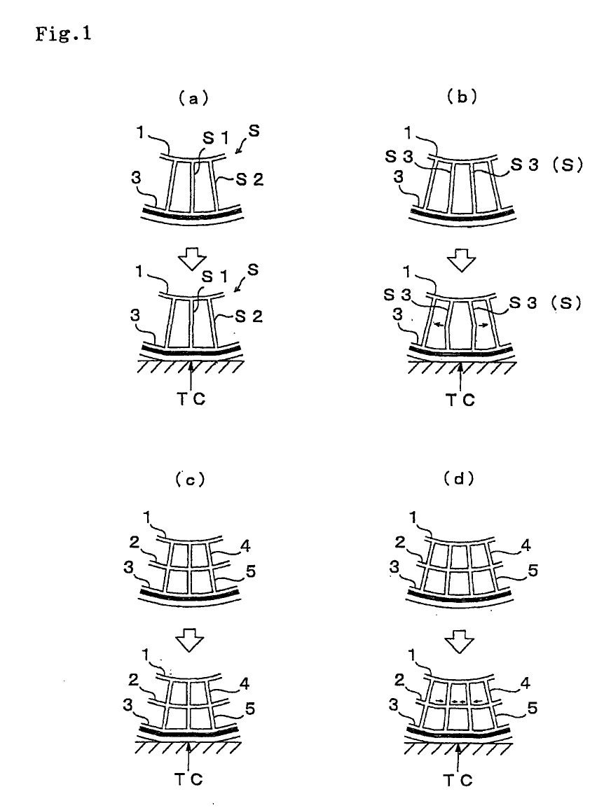

The tensile modulus of the outer annular portion 3 can be set to the same level as the inner annular portion 1 in the case where the reinforcing layer 6 is provided in the outer periphery of the outer annular portion 3, as shown in FIG. 1. In such a case where the reinforcing layer 6 is not provided, the tensile modulus is preferably between 5 and 180000 MPa, and more preferably between 7 and 50000 MPa, in view of achieving the weight saving and the improvement in durability while sufficiently transmitting the force from the outer coupling portion 5.

In the case of enhancing the tensile modulus of the outer annular portion 3, it is preferable to use the fiber reinforced material obtained by reinforcing the elastic material by the fiber or the like. The outer annular portion 3 and the belt layer or the like are sufficiently bonded by reinforcing the outer annular portion 3 by the reinforcing fiber.

The inner coupling portion 4 is structured such as to couple the inner annular portion 1 and the intermediate annular portion 2, and a plurality of inner coupling portions 4 are provided so as to be independent in the circumferential direction, for example, by setting a suitable interval between the inner annular portion 1 and the intermediate annular portion 2. In view of improving the uniformity, it is preferable that the inner coupling portions 4 are provided spaced apart at fixed intervals.

The number of the inner coupling portions 4 at the time of being provided over the entire periphery (a plurality of inner coupling portions provided in the axial direction are counted as one) is preferably between 10 and 80, and more preferably between 40 and 60, in view of achieving the weight saving, the improvement in power transmission, the improvement in durability, while sufficiently supporting the load from the vehicle. FIG. 3 shows the example where forty inner coupling portions 4 are provided.

As a shape of the individual inner coupling portion 4, a tabular body, a columnar body and the like can be listed up, however, an example of the tabular body is shown in the present embodiment. The inner coupling portion 4 extends in a tire diametrical direction or a direction which is inclined from the tire diametrical direction, in a front view cross section. In the present invention, in view of improving a durability as well as making the rigidity fluctuation hard to be generated by making the break point high, it is preferable that the extending direction of the inner coupling portion 4 is within ±30 degree in the tire diametrical direction in the front view cross section, and it is more preferable that the extending direction is within ±15 degree in the tire diametrical direction. FIG. 3 shows an example in which the inner coupling portion 4 is extended in a direction which is inclined only at an angle θ from the tire diametrical direction. Further, in this example, the adjacent inner coupling portions 4 are inclined only at the angle θ in the opposite direction to each other with respect to the tire diametrical direction.

A thickness of the inner coupling portion 4 is preferably between 4 and 12% of the tire cross sectional height H1, and more preferably between 6 and 10%, in view of achieving a weight saving, an improvement of a durability and an improvement of a transverse rigidity while sufficiently transmitting the force from the inner annular portion 1.

The tensile modulus of the inner coupling portion 4 is preferably between 5 and 50 MPa, and more preferably between 7 and 20 MPa, in view of achieving the weight saving, the improvement in durability, and the improvement in lateral rigidity, while sufficiently transmitting the force from the inner annular portion 1.

In the case of enhancing the tensile modulus of the inner coupling portion 4, it is preferable to use the fiber reinforced material obtained by reinforcing the elastic material by the fiber or the like.

The outer coupling portion 5 is structured such as to couple the outer annular portion 3 and the intermediate annular portion 2, and a plurality of outer coupling portions are provided so as to be independent in the circumferential direction, for example, by forming a suitable interval between the outer annular portion 3 and the intermediate annular portion 2. In view of improving the uniformity, it is preferable that the outer coupling portions 5 are provided spaced apart at fixed intervals.

In this case, the outer coupling portion 5 and the inner coupling portion 4 may be provided at the same position of an entire circumference, or may be provided at different positions. In other words, the outer coupling portion 5 and the inner coupling portion 4 are not necessarily provided in an extending manner in such a manner as to be continuous in the same direction as shown in FIG. 3.

The number of the outer coupling portions 5 at the time of being provided over the entire periphery (a plurality of outer coupling portions provided in the axial direction are counted as one) is preferably between 10 and 80, and more preferably between 40 and 60, in view of achieving the weight saving, the improvement in power transmission, the improvement in durability, while sufficiently supporting the load from the vehicle. FIG. 3 shows the example where forty outer coupling portions 5 are provided in the same manner as the inner coupling portion 4.

As the shape of the individual outer coupling portion 5, there can be listed up a tabular shape, a columnar shape and the like, however, the example of the tabular shape is shown in the present embodiment. These outer coupling portions 5 extend in the tire diametrical direction or a direction which is inclined from the tire diametrical direction, in a front view cross section. In the present invention, an extending direction of the outer coupling portion 5 is preferably within ±30 degree in the tire diametrical direction, and more preferably within ±15 degree in the tire diametrical direction, in the front view cross section, in view of improving the durability, while increasing a break point so as to make a rigidity fluctuation hard to be generated. FIG. 3 shows the example in which the outer coupling portion 5 is extended in a direction which is inclined only at an angle θ from the tire diametrical direction. Further, in this example, the adjacent outer coupling portions 5 are inclined at the angle θ in the opposite direction to each other with respect to the tire diametrical direction.

A thickness of the outer coupling portion 5 is preferably between 4 and 12% the tire cross sectional height H1, and more preferably between 6 and 10%, in view of achieving the weight saving, the improvement of the durability, and the improvement of the transverse rigidity, while sufficiently transmitting the force from the inner annular portion 1.

The tensile modulus of the outer coupling portion 5 is preferably between 5 and 50 MPa, and more preferably between 7 and 20 MPa, in view of achieving the weight saving, the improvement in durability and the improvement in lateral rigidity, while sufficiently transmitting the force from the inner annular portion 1.

In the case of enhancing the tensile modulus of the outer coupling portion 5, it is preferable to use the fiber reinforced material obtained by reinforcing the elastic material by the fiber or the like.

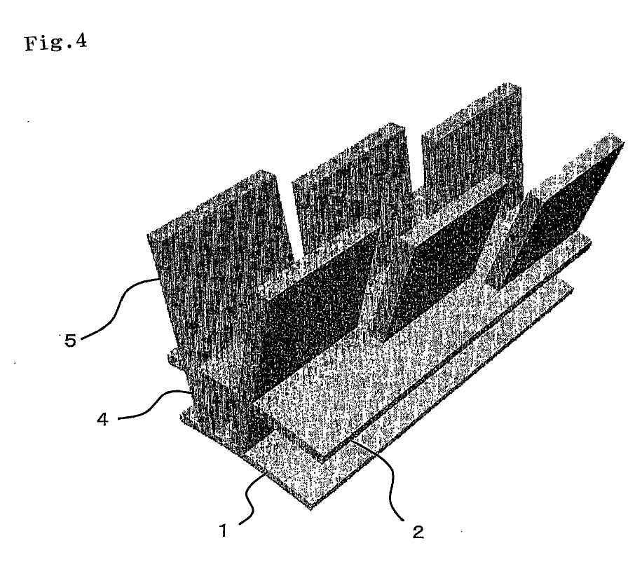

In this case, a perspective view in which a part of the support structure body SS is enlarged is shown in FIG. 4. For convenience of explanation, the outer annular portion 3 is not illustrated in FIG. 4. Further, in a side elevational view in FIG. 3, a coupling portion between the outer coupling portion 5 and the outer annular portion 3 is shown by a broken line. In other words, as is known from FIGS. 3 and 4, the inner coupling portion 4 and the outer coupling portion 5 are divided in the tire width direction, are independent in the tire circumferential direction and are shifted from each other in the tire circumferential direction per zones which are divided in the tire width direction. In this case, there is shown an example in which the zone is divided into three sections in the tire width direction, however, the number of the zones is not limited to three. In this case, in FIG. 3A, for convenience of explanation, only the outer coupling portion 5 in the hithermost zone is illustrated.

In the present embodiment, as shown in FIG. 3, there is shown the example in which the reinforcing layer 6 reinforcing the bending deformation of the outer annular portion 3 is provided in an outer side of the outer annular portion 3 of the support structure body SS. Further, in the present embodiment, as shown in FIG. 3, there is shown the example in which a tread layer 7 is provided further outside the reinforcing layer 6. As the reinforcing layer 6 and the tread layer 7, it is possible to provide a similar structure to the belt layer of the conventional pneumatic tire. Further, it is possible to provide a similar pattern to the conventional pneumatic tire, as the tread pattern.

Hereinafter, an example or the like specifically showing the structure and the effect of the present invention will be described. Measurement was carried out by setting an evaluation item in the example as follows.

(1) Variance of Ground Pressure

A distribution of the ground pressure of the ground surface is measured in respective ground states, while gradually rolling (rotating) the non-pneumatic tire, that is, gradually changing the position of the outer end point of the outer coupling portion 5 (the outer spoke) with respect to the center position of the ground surface, in a state in which the vertical load 2500 N is applied. The variance of the ground pressure in each of the ground states is then calculated based on the distribution of the ground pressure, and the value of the variance of the ground pressure in the ground state in which the value of the variance becomes maximum is evaluated. It is indicated by an index number by setting the maximum value of the variance of the ground pressure in the comparative example 1 to 100, and the smaller the value is, the more excellent it is.

(2) Vertical Rigidity Value

A vertical rigidity value is an average value obtained by dividing a load by each of a deflection amount at a position where the deflection amount becomes maximum, and a deflection amount at a position where the deflection amount becomes minimum, when optionally changing a position of an outer end point of an outer spoke with respect to a ground surface at a time of applying a vertical load 2500 N, and is shown by an index number at a time of setting an example 1 to 100. The larger the value is, the higher the vertical rigidity is. In this case, the deflection amount is measured based of a displacement of a tire axial core.

(3) Vertical Rigidity Difference

A vertical rigidity difference is a difference obtained by dividing a load by each of a deflection amount at a position where the deflection amount becomes maximum, and a deflection amount at a position where the deflection amount becomes minimum, when optionally changing a position of an outer end point of an outer spoke with respect to a ground surface at a time of applying a vertical load 2500 N, and is shown by an index number at a time of setting an example 1 to 100. The smaller the value is, the more an evenness of the rigidity is.

(4) Rigidity Fluctuation Test

First of all, a deflection amount is measured while rolling (rotating) the non-pneumatic tire little by little, that is, changing a position of an outer end point of an outer spoke (corresponding to the outer coupling portion 5) little by little with respect to a center position of a ground surface with the vertical load 2500 N being applied. Next, a position at which the deflection amount becomes maximum and a position at which the deflection amount becomes minimum in all the ground states is decided, that is, a position at which the rigidity becomes minimum and a position at which the rigidity becomes maximum is decided. Further, it is searched how a difference of vertical rigidity (a rigidity fluctuation) changes, by measuring a change of the deflection amount at that time while increasing the applied vertical load little by little, in these both positions.

(5) Bench Tire Single Noise Test

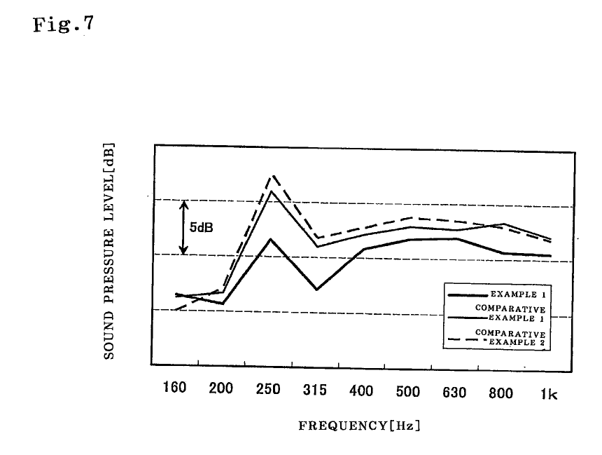

The bench tire single noise test is carried out in accordance with JAS0-C606. A speed is set to 40 km/h, and a vertical load 2500 N is applied. Results of the test are shown in FIG. 7. The bench tire single noise in FIG. 7 is obtained by measuring one third octave band sound pressure level and plotting with respect to a frequency.

(6) Car Interior Sound Evaluating Test

Each of the non-pneumatic tires is installed to a domestic light car, and a sensory evaluation is carried out with respect to the car interior sound at a time of steady traveling at a speed 40 km/h. The evaluation is carried out on a scale of one to ten, and the higher point is more excellent.

### Example 1

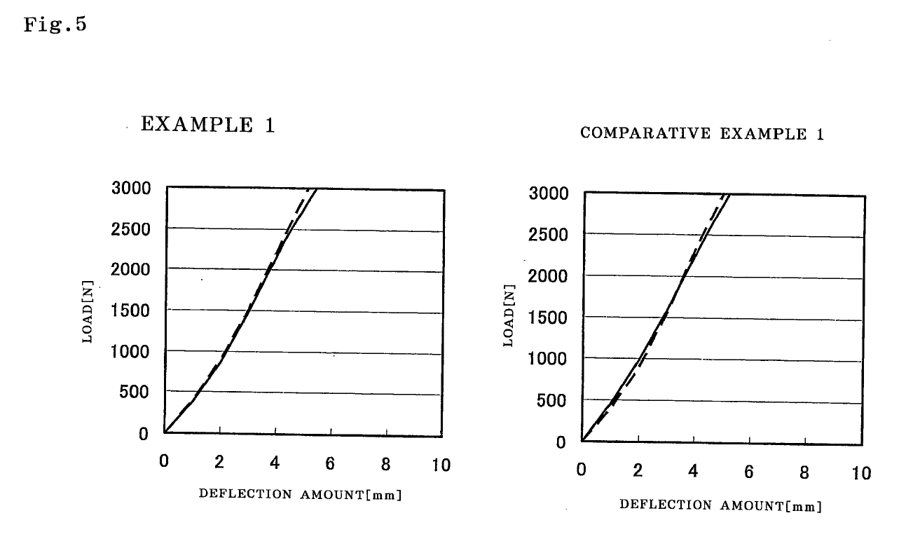

The performance mentioned above was evaluated by preparing a non-pneumatic tire having the support structure body provided with the inner ring (corresponding to the inner ring portion 1), the intermediate ring (corresponding to the internal annular portion 2), the outer ring (corresponding to the outer annular portion 3), the inner spoke (corresponding to the inner coupling portion 4), and the outer spoke (corresponding to the outer coupling portion 5), three layers of reinforcing layers provided in the outer periphery thereof, and the tread rubber in accordance with dimensions, physical properties and the like shown in Table 1. The inner spoke and the outer spoke are divided in the tire width direction, are independent in the tire circumferential direction, provided so as to be shifted from each other in the tire circumferential direction per zones which are divided in the tire width direction, and are shown as “with” phase displacement in Table 1. Results of the variance of the ground pressure, the vertical rigidity value, and the vertical rigidity difference are shown together in Table 1. Further, results of the rigidity fluctuation test are shown in FIG. 5, and results of the bench tire single noise test are shown in FIG. 7.

In this case, the widths in the axial direction of the rings were all set to 140 mm. Further, in the example and the comparative example in which the zone is divided into a plurality of zones in the tire width direction, the number of the divided zones was set to three, and the zone was uniformly divided. Further, the inner spoke and the outer spoke were provided side by side in the tire diametrical direction (refer to FIG. 3). Further, the support structure body was formed, with the use of a metal mold having a space portion corresponding to the support structure body, by filling and hardening a raw material liquid (isocyanate low end pre-polymer: Sofrannate manufactured by Toyo Rubber Industry Co., Ltd., setting agent: MOCA manufactured by Ihara Chemical Industry Co., Ltd.) of an elastic material (a polyurethane resin) in the space portion by using an urethane casting machine.

### Comparative Example 1

In the same manner as the example 1, the performance mentioned above was evaluated by forming the support structure body provided with the inner ring, the intermediate ring, the outer ring, the inner spoke, and the outer spoke, and preparing the non-pneumatic tire having three layers of reinforcing layers provided in the outer periphery thereof, and the tread rubber, in accordance with dimensions, physical properties and the like shown in Table 1. In this case, in the comparative example 1, the inner spoke and the outer spoke are not divided in the tire width direction, but are continuous all over a whole region in the tire width direction, and are shown as “without” phase displacement in Table 1. Results of the variance of the ground pressure, the vertical rigidity value, and the vertical rigidity difference are shown together in Table 1. Further, results of the rigidity fluctuation test are shown in FIG. 5, and results of the bench tire single noise test are shown in FIG. 7.

### Comparative Example 2

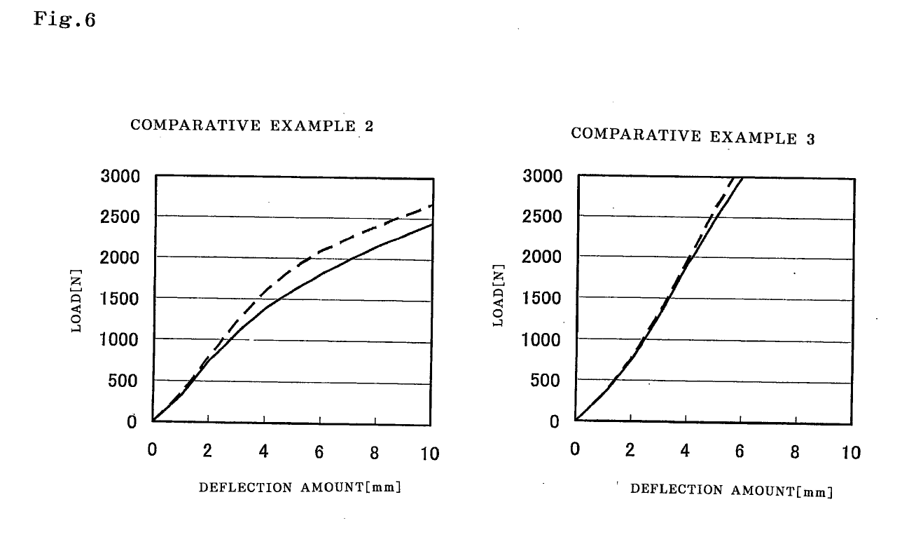

In the same manner as the example 1, the performance mentioned above was evaluated by forming the support structure body provided with the inner ring, the outer ring, the inner spoke, and the outer spoke, and preparing the non-pneumatic tire having three layers of reinforcing layers provided in the outer periphery thereof, and the tread rubber, in accordance with dimensions, physical properties and the like shown in Table 1. In this case, in the comparative example 2, the intermediate ring is not provided as is different from the example 1, and the inner spoke and the outer spoke construct one spoke continuously in the tire diametrical direction, and couple the inner ring and the outer ring. Results of the variance of the ground pressure, the vertical rigidity value, and the vertical rigidity difference are shown together in Table 1. Further, results of the rigidity fluctuation test are shown in FIG. 6, and results of the bench tire single noise test are shown in FIG. 7.

### Comparative Example 3

In the same manner as the example 1, the performance mentioned above was evaluated by forming the support structure body provided with the inner ring, the intermediate ring, the outer ring, the inner spoke, and the outer spoke, and preparing the non-pneumatic tire having three layers of reinforcing layers provided in the outer periphery thereof, and the tread rubber, in accordance with dimensions, physical properties and the like shown in Table 1. In this case, in the comparative example 3, the outer ring is not reinforced by the reinforcing fiber. Results of the variance of the ground pressure, the vertical rigidity value, and the vertical rigidity difference are shown together in Table 1. Further, results of the rigidity fluctuation test are shown in FIG. 6.

TABLE 1

| | Data and physical | | Comparative | Comparative | Comparative |
|---|---|---|---|---|---|
| | properties | Example 1 | example 1 | example 2 | example 3 |
| Inner ring | Inner diameter [mm] | 177.4 | 177.4 | 177.4 | 177.4 |
| | Thickness [mm] | 3 | 3 | 3 | 3 |
| | Tensile modulus [MPa] | 16 | 16 | 16 | 16 |
| Inner spoke | Thickness [mm] | 6 | 6 | 6 | 6 |
| | Tensile modulus [MPa] | 16 | 16 | 16 | 16 |
| | angle of inclination | 12 | 12 | 12 | 12 |
| | with respect to tire | | | | |
| | diametrical direction | | | | |
| | [deg] | | | | |
| Intermediate | Inner diameter [mm] | 200.9 | 200.9 | — | 200.9 |
| ring | Thickness [mm] | 4 | 4 | — | 4 |
| | Tensile modulus [MPa] | 16 | 16 | — | 16 |
| Inner ring | Cord cross sectional | 2.1 | 2.1 | — | 2.1 |
| reinforcement | area [mm²] | | | | |
| | Circumferential | 3 | 3 | — | 3 |
| | direction cord striking | | | | |
| | number [number/25.4 mm] | | | | |
| | Cord angle [deg] | 0 | 0 | — | 0 |
| | Width direction cord | 3 | 3 | — | 3 |
| | striking number | | | | |
| | [number/25.4 mm] | | | | |
| | Cord angle [deg] | 90 | 90 | — | 90 |
| | Cord tensile modulus | 10980 | 10980 | — | 10980 |
| | [MPa] | | | | |
| Outer spoke | Thickness [mm] | 6 | 6 | 6 | 6 |
| | Tensile modulus [MPa] | 16 | 16 | 16 | 16 |
| | Angle of inclination | 12 | 12 | 12 | 12 |
| | with respect to tire | | | | |
| | diametrical direction | | | | |
| | [deg] | | | | |
| Outer ring | Inner diameter [mm] | 249.4 | 249.4 | 249.4 | 249.4 |
| | Thickness [mm] | 2 | 2 | 2 | 2 |
| | Tensile modulus [MPa] | 16 | 16 | 16 | 16 |
| Outer ring | Cord cross sectional | 2.1 | 2.1 | 2.1 | — |
| reinforcement | area [mm²] | | | | |
| | Circumferential | 3 | 3 | 3 | — |
| | direction cord striking | | | | |
| | number [number/25.4 mm] | | | | |
| | Cord angle [deg] | 0 | 0 | 0 | — |
| | Width direction cord | 3 | 3 | 3 | — |
| | striking number | | | | |
| | [number/25.4 mm] | | | | |
| | Cord angle [deg] | 90 | 90 | 90 | — |
| | Cord tensile modulus | 10980 | 10980 | 10980 | — |
| | [MPa] | | | | |
| Tread rubber | Thickness [mm] | 8 | 8 | 8 | 8 |
| | Tensile modulus [MPa] | 2.6 | 2.6 | 2.6 | 2.6 |
| Tread | Cord line diameter [mm] | 0.25 | 0.25 | 0.25 | 0.25 |
| reinforced | Cord striking number | 23 | 23 | 23 | 23 |
| layer 1 | [number/25.4 mm] | | | | |
| | Cord tensile modulus | 180000 | 180000 | 180000 | 180000 |
| | [MPa] | | | | |
| | Cord angle [deg] | 20 | 20 | 20 | 20 |
| Tread | Cord line diameter [mm] | 0.25 | 0.25 | 0.25 | 0.25 |
| reinforced | Cord striking number | 23 | 23 | 23 | 23 |
| layer 2 | [number/25.4 mm] | | | | |
| | Cord tensile modulus | 180000 | 180000 | 180000 | 180000 |
| | [MPa] | | | | |
| | Cord angle [deg] | −20 | −20 | −20 | −20 |
| Tread | Cord line diameter | 0.25 | 0.25 | 0.25 | 0.25 |
| reinforced | Cord striking number | 23 | 23 | 23 | 23 |
| layer 3 | [number/25.4 mm] | | | | |
| | Cord tensile modulus | 180000 | 180000 | 180000 | 180000 |
| | [MPa] | | | | |
| | Cord angle [deg] | 20 | 20 | 20 | 20 |
| Inclined spoke number | | 40 | 40 | 40 | 40 |
| Divided number in width direction | | 3 | — | 3 | 3 |
| Phase shift | | With | Without | With | With |
| Variance of | Index number (smaller | 100 | 183 | 215 | 105 |
| ground | value is more excellent) | | | | |
| pressure | | | | | |
| Vertical | Index number (the larger | 100 | 103 | 47 | 90 |
| rigidityvalue | the value is, the higher | | | | |
| | the rigidity is) | | | | |
| Vertical | Index number (smaller | 100 | 102 | 285 | 110 |
| rigidity | value is more excellent) | | | | |
| difference | | | | | |

From the results of Table 1 and FIGS. 5 to 7, the following matters are known. The non-pneumatic tire in accordance with the example 1 has the very small variance of the ground pressure and is excellent in comparison with the non-pneumatic tire in accordance with the comparative example 1. This is an effect obtained by the outer spokes shifting from each other in the tire circumferential direction improving the rigidity of the outer ring between the outer spokes which are adjacent in the tire circumferential direction in the adjacent zone. Further, the vertical rigidity value and the vertical rigidity difference between the both are approximately the same, however, the rigidity fluctuation in the low load region is a little larger in the comparative example 1 in comparison with the example 1. In the bench tire single noise of the example 1, the sound pressure level at the frequency 250 Hz coming to a peak in the case of the speed 40 km/h is 4.4 dB lowered in comparison with the comparative example 1. It is considered that in spite of the approximately same vertical rigidity value and the vertical rigidity difference, the noise performance of the example 1 is excellent in comparison with the comparative example 1, because the variance of the ground pressure is very excellent.

The non-pneumatic tire in accordance with the example 1 is very excellent in the variance of the ground pressure, the vertical rigidity value and the vertical rigidity difference in comparison with the non-pneumatic tire in accordance with the comparative example 2. Further, the rigidity fluctuation of the comparative example 2 is very large in comparison with the example 1. In the bench tire single noise of the example 1, the sound pressure level at the frequency 250 Hz coming to the peak in the case of the speed 40 km/h is 6.0 dB lowered in comparison with the comparative example 2, and the reduction of the noise appears. The difference between the comparative example 2 and the example 1 is with or without the intermediate ring, and when the non-pneumatic tire is provided with the intermediate ring, the fluctuation in the circumferential direction of the tire rigidity is suppressed, and it is possible to know that the noise is reduced in approximately all the frequency bands.

The non-pneumatic tire in accordance with the example 1 is excellent in the variance of the ground pressure, the vertical rigidity value and the vertical rigidity difference in comparison with the non-pneumatic tire in accordance with the comparative example 3. Further, the rigidity fluctuation in the high load region becomes large in the comparative example 3 in comparative with the example 1. It is considered that since the comparative example 3 is not reinforced in the outer ring, an adhesive property between the outer ring and the reinforced layer is deteriorated, the vertical rigidity value is lowered, and the rigidity fluctuation becomes large in the high load region.

Further, the results of the car interior sound evaluation test indicate that the example 1 has the point 7, the comparative example 1 has the point 5, and the comparative example 2 has the point 4. Accordingly, the example 1 has the high point, and is excellent in the car interior sound evaluation.

### Other Examples

In the example mentioned above, there is shown the example in which only one intermediate annular portion 2 is provided, however, in the present invention, a plurality of intermediate annular portions 2 may be provided. Accordingly, it is possible to make the inner diameter of the inner annular portion 2 smaller.

Further, in the example mentioned above, there is shown the example in which the intermediate annular portion 2 has the same radius in all the zones in the tire width direction, however, may have different radii per zones.

The support structure body SS may be integrally formed as a whole, however, may be structured by integrating the parts formed per the zones which are divided in the tire width direction, by an adhesion or the like.

What is claimed is:

1. A non-pneumatic tire comprising:
a support structure body supporting a load from a vehicle,
the support structure body including:
an inner annular portion,
an intermediate annular portion concentrically provided in an outer side of the inner annular portion,
an outer annular portion concentrically provided in an outer side of the intermediate annular portion,
a plurality of inner coupling portions coupling the inner annular portion and the intermediate annular portion; and
a plurality of outer coupling portions coupling the outer annular portion and the intermediate annular portion, wherein
the inner coupling portions and the outer coupling portions are divided in a tire width direction, are independent in a tire circumferential direction, and are provided so as to be shifted from each other in the tire circumferential direction per zones which are divided in the tire width direction.

2. A non-pneumatic tire as claimed in claim 1, wherein each of the inner coupling portion and the outer coupling portion is extended in a direction which is inclined from the tire diametrical direction.

3. A non-pneumatic tire as claimed in claim 1, wherein the outer annular portion is continuous in the tire circumferential direction, and is reinforced by a reinforcing fiber.
